(19) United States
(12) Patent Application Publication
(10) Pub. No.: US 2005/0178043 A1
(43) Pub. Date: Aug. 18, 2005

(54) Navigable waterfowl retrieving apparatus, retrieving apparatus for waterborne objects, and method for retrieving waterfowl carcasses from a body of water

(75) Inventors: Duane C. Markley, Spokane Valley, WA (US); Ron Stokes, Spokane Valley, WA (US)

Correspondence Address: WELLS ST. JOHN P.S., 601 W. FIRST AVENUE, SUITE 1300, SPOKANE, WA, 99201, US

(73) Assignee: Eagle Mountain Brokers, Inc.

(21) Appl. No.: 11/046,506

(22) Filed: Jan. 28, 2005

Related U.S. Application Data
(60) Provisional application No. 60/539,877, filed on Jan. 28, 2004.

(51) Int. Cl. A01M 31/00

(52) U.S. Cl. 43/26.1

(57) ABSTRACT

A navigable waterfowl retrieving apparatus is provided. The apparatus includes a body having a fishing line eyelet, a propulsion mechanism supported by the body, a steering mechanism supported by the body, and a waterfowl grappling mechanism supported by the body and configured to couple with a floating waterfowl carcass when engaged with the grappling mechanism via navigable movement of the body about a body of water. A method for retrieving waterfowl carcasses from a body of water is also provided.

### RELATED PATENT DATA

This application claims the benefit of U.S. Provisional Patent Application Ser. No. 60/539,877, which was filed on Jan. 28, 2004, and which is incorporated by reference herein and made a part hereof.

### TECHNICAL FIELD

The present invention pertains to a remote-controlled and self-propelled navigable waterfowl retrieving apparatus. More particularly, the present invention relates to waterfowl retrievers and transmitting control devices for use with remote-controlled and self-propelled waterfowl retrievers that are used in conjunction with fishing poles.

### BACKGROUND OF THE INVENTION

Numerous attempts have been made to realize the retrieval of water game, such as waterfowl carcasses, from a body of water when hunting for waterfowl (or birds) without using a dog or a boat. Traditionally, many duck hunters have raised and trained dogs, such as Labrador retrievers to use their skills in retrieving waterfowl carcasses from bodies of water when hunting. However, the upbringing, training, and maintenance requirements for such hunting dogs can be considerable. Accordingly, several attempts have been made to provide substitute retrieval mechanisms.

In one case, remote-controlled, miniature waterfowl decoys have been utilized to assist in placing decoys in a desired location within a body of water. For example, U.S. Pat. Nos. 3,689,927; 5,377,439; and 6,601,333, as well as published U.S. Patent Application Publication No. 2004/0025770 A1, herein incorporated by reference, are directed to such remote-controlled waterfowl decoys. These various inventions are directed to devices that enable an angler to remotely position a decoy within a body of water. However, none of these decoys are capable of being affixed onto an existing fishing line and cast by an angler into a body of water. Secondly, improvements are needed in the manner in which input signals are delivered from a transmitter to such devices for remotely navigating the devices to desired locations within a body of water.

Secondly, various devices are known for retrieving waterfowl carcasses from a body of water. By way of example, U.S. Pat. Nos. 2,857,439; 3,026,545; 4,545,315; 5,377,439; and 6,601,333, as well as published U.S. Patent Application Publication No. 2004/0025770 A1, herein incorporated by reference, show various waterfowl carcass retrieval apparatus. For example, U.S. Pat. No. 6,601,333 includes a control module that has transmitting circuitry that communicates with the retrieval apparatus to navigate the apparatus to collect and retrieve a waterfowl carcass from a body of water using a game retrieval device in the form of a snare or hook. However, these waterfowl retrieval apparatus tend to be rather bulky and obtrusive, and are not capable of being attached onto a retrieval line and cast with a fishing pole. Accordingly, improvements are needed, particularly when incorporating waterfowl retrieval features into a compact apparatus that is capable of being attached to a retrieval line and cast into a body of water using a fishing pole and retrieval line, such as a fishing line.

### SUMMARY OF THE INVENTION

A waterfowl retrieval apparatus, such as a castable retrieving apparatus, is provided in combination with a transmitter control device that is incorporated inside a handle component of a fishing pole to enable remote control of the apparatus, which is also self-propelled and navigable. According to one construction, the remote-controlled and self-propelled apparatus comprises a dog-shaped retrieval apparatus. According to one construction, the transmitting control device comprises remote control transmitting circuitry that is installed within a handle of a fishing pole. The waterfowl retrieval apparatus is provided with a propulsion mechanism and steering mechanism in conjunction with the control circuitry to enable navigation of the retrieval apparatus along desired paths and in desired locations across or within a body of water.

A fishing pole, a duck retriever, a goose retriever, and a bird retriever are provided with remote controls installed in the handle of the pole (or a separate control unit) and one or more receivers are installed in the duck, goose, or bird retriever, along with a propulsion mechanism and steering mechanisms. This allows the hunter/angler to control various axes of movement of the duck, goose or bird retriever from the handle of the hunter/angler's pole or a separate control unit. This also allows the hunter/angler to place the duck, goose or bird retriever in the position he chooses without repeatable casting efforts or, if he wants, he can also choose not to cast and physically start the duck, goose or bird retriever at his side and control it to the location he wants.

According to one aspect, a fishing pole is provided with a radio frequency (RF) radio or infrared (IR) transmitter and functional user controls. The duck, goose or bird retriever is provided with a radio receiver that receives signals from the transmitter and in turn supplies the signal to the servo and electric motor. The servo then supplies the function of steering the duck, goose or bird retriever by moving linkages attached to a rudder placed at the stem of the duck, goose or bird retriever. The electric motor supplies the function of moving the duck, goose or bird retriever either forward or backward by turning a propeller that resides at the stern and outside the body of the duck, goose or bird retriever. The power is provided by rechargeable batteries such as NiCAD, Li-Poly or NiMH batteries, or non-rechargeable batteries such as alkaline batteries. The hunter/angler supplies input to the user controls on the handle and the signal is transmitted from the transmitter in the handle to the receiver in the duck, goose or bird retriever.

According to another aspect, a fishing pole is provided with a radio frequency (RF) radio or infrared (IR) transmitter and functional user controls. The duck, goose or bird retriever is provided with a radio receiver that receives signals from the transmitter and, in turn, supplies the signal to actuators and an electric motor. The actuators then supply the function of steering the duck, goose or bird retriever by moving rotational positioning of the rudder at the stern of the duck, goose or bird retriever. The electric motor supplies the motive force to move the duck, goose or bird retriever either forward or backward by turning a propeller that resides at the stern and outside the body of the duck, goose or bird retriever.

According to another aspect, a fishing pole is provided with a radio frequency (RF) radio or infrared (IR) transmitter and functional user controls. The duck, goose or bird retriever is provided with a radio receiver that receives signals from the transmitter and in turn supplies an electrical charge to current-controlled wire (such as Nitinol) that in turn changes length (or shape) as a charge is applied or removed, thereby causing the rudder to move to one side or the other. The electric motor supplies the function of moving the duck, goose or bird retriever either forward or backward by turning a propeller that resides at the stern and outside the body of the duck, goose or bird retriever.

According to another aspect, a fishing pole is provided with a radio frequency (RF) radio or infrared (IR) transmitter and functional user controls. The duck, goose or bird retriever is provided with a radio receiver that receives signals from the transmitter and in turn supplies a signal to an electrical motor (or several motors) that turns a series of gears and moves a rudder to one side or the other. The electric motor supplies the motive force to move the duck, goose or bird retriever either forward or backward by turning a propeller that resides at the stern and outside the body of the duck, goose or bird retriever.

According to still another aspect, a fishing pole is provided with a radio frequency (RF) radio or infrared (IR) transmitter and functional user controls. The duck, goose or bird retriever is provided with a radio receiver that receives signals from the transmitter and in turn supplies the signal to the servo and electric motor. The servo then supplies the function of steering the duck, goose or bird retriever by moving an articulating fin, body, hook, and/or tail of the duck, goose or bird retriever either forward or backward by turning a propeller that resides at the stern and outside the body of the duck, goose or bird retriever.

According to another aspect, a fishing pole is provided with a radio frequency (RF) radio or infrared (IR) transmitter and functional user controls. The duck, goose or bird retriever is provided with a radio receiver that receives signals from the transmitter and in turn supplies the signal to actuators and an electric motor. The actuators then supply the function of steering the duck, goose or bird retriever by moving an articulating fin, body, hook, and/or tail. The electric motor supplies the function of moving the duck, goose or bird retriever either forward or backward by turning a propeller that resides at the stern and outside the body of the duck, goose or bird retriever.

According to another aspect, a fishing pole is provided with a radio frequency (RF) radio or infrared (IR) transmitter and functional user controls. The duck, goose or bird retriever is provided with a radio receiver that receives signals from the transmitter and in turn supplies an electrical charge to current-controlled wire that in turn changes length or shape as a charge is applied or removed causing the articulating fin, body, hook, and/or tail to move to one side or the other. The electric motor supplies the function of moving the duck, goose or bird retriever either forward or backward by turning a propeller that resides at the stern and outside the body of the duck, goose or bird retriever.

According to another aspect, a fishing pole is provided with a radio frequency (RF) radio or infrared (IR) transmitter and functional user controls. The duck, goose or bird retriever is provided with a radio receiver that receives signals from the transmitter and in turn supplies a signal to an electrical motor or several motors that turns a series of gears and moves an articulating fin, body, hook, and/or tail to one side or the other. The electric motor supplies the function of moving the duck, goose or bird retriever either forward or backward by turning a propeller that resides at the stern and outside the body of the duck, goose or bird retriever.

According to still another aspect, a fishing pole is provided with a radio frequency (RF) radio or infrared (IR) transmitter and functional user controls. The duck, goose or bird retriever is provided with a radio receiver that receives signals from the transmitter and in turn supplies the signal to the servo and electric motor. The servo then supplies the function of steering the duck, goose or bird retriever by moving an articulating jet drive. The electric motor supplies the function of moving the duck, goose or bird retriever either forward or backward by turning a jet drive that resides at the stern and outside the body of the duck, goose or bird retriever.

According to another aspect, a fishing pole is provided with a radio frequency (RF) radio or infrared (IR) transmitter and functional user controls. The duck, goose or bird retriever is provided with a radio receiver that receives signals from the transmitter and in turn supplies the signal to actuators and an electric motor. The actuators then supply the function of steering the duck, goose or bird retriever by moving an articulating jet drive. The electric motor supplies the function of moving the duck, goose or bird retriever either forward or backward by turning a jet drive that resides in the stern and outside the body of the duck, goose or bird retriever.

According to another aspect, a fishing pole is provided with a radio frequency (RF) radio or infrared (IR) transmitter and functional user controls. The duck, goose or bird retriever is provided with a radio receiver that receives signals from the transmitter and in turn supplies an electrical charge to current-controlled wire that in turn changes length or shape as a charge is applied or removing causing the articulating jet drive to move to one side or the other. The electric motor supplies the function of moving the duck, goose or bird retriever either forward or backward by turning a jet drive that resides at the stern and outside the body of the duck, goose or bird retriever.

According to another aspect, a fishing pole is provided with a radio frequency (RF) radio or infrared (IR) transmitter and functional user controls. The duck, goose or bird retriever is provided with a radio receiver that receives signals from the transmitter and in turn supplies a signal to an electrical motor or several motors that turns a series of gears and moves an articulating jet drive to one side or the other. The electric motor supplies the function of moving the duck, goose or bird retriever either forward or backward by turning a jet drive that resides at the stern and outside the body of the duck, goose or bird retriever.

According to another aspect, a fishing pole is provided with a radio frequency (RF) radio or infrared (IR) transmitter and functional user controls. The duck, goose or bird retriever is provided with a radio receiver that receives signals from the transmitter and in turn supplies the signal to the servo and electric motor. The servo then supplies the function of steering the duck, goose or bird retriever by moving linkages attached to a rudder placed at the stern of the duck, goose or bird retriever. The electric motor supplies the function of moving the duck, goose or bird retriever either forward or backward by turning an impeller.

According to another aspect, a fishing pole is provided with a radio frequency (RF) radio or infrared (IR) transmitter and functional user controls. The duck, goose or bird retriever is provided with a radio receiver that receives signals from the transmitter and in turn supplies the signal to actuators and an electric motor. The actuators that supply the function of steering the duck, goose or bird retriever by moving the rudder placed at the stern of the duck, goose or bird retriever. The electric motor supplies the function of moving the duck, goose or bird retriever either forward or backward by turning an impeller.

According to another aspect, a fishing pole is provided with a radio frequency (RF) radio or infrared (IR) transmitter and functional user controls. The duck, goose or bird retriever is provided with a radio receiver that receives signals from the transmitter and in turn supplies an electrical charge to current-controlled wire that in turn changes length as a charge is applied or removed causing the rudder to move to one side or the other. The electric motor supplies the function of moving the duck, goose or bird retriever either forward or backward by turning an impeller.

According to another aspect, a fishing pole is provided with a radio frequency (RF) radio or infrared (IR) transmitter and functional user controls. The duck, goose or bird retriever is provided with a radio receiver that receives signals from the transmitter and in turn supplies a signal to an electrical motor or several motors that turns a series of gears and moves a rudder to one side or the other. The electric motor supplies the function of moving the duck, goose or bird retriever either forward or backward by turning an impeller.

According to still another aspect, a fishing pole is provided with a radio frequency (RF) radio or infrared (IR) transmitter and functional unit controls. The duck, goose or bird retriever is provided with a radio receiver that receives signals from the transmitter and in turn supplies the signal to the servo and electric motor. The servo then supplies the function of steering the duck, goose or bird retriever by moving an articulating fin, body, hook, and/or tail of the duck, goose or bird retriever. The electric motor supplies the function of moving the duck, goose or bird retriever either forward or backward by using an impeller.

According to another aspect, a fishing pole is provided with a radio frequency (RF) radio or infrared (IR) transmitter and functional user controls. The duck, goose or bird retriever is provided with a radio receiver that receives signals from the transmitter and in turn supplies the signal to actuators and an electric motor. The actuators then supply the function of steering the duck, goose or bird retriever by moving an articulating fin/boy/hook/tail. The electric motor supplies the function of moving the duck, goose or bird retriever either forward or backward by turning an impeller.

According to another aspect, a fishing pole is provided with a radio frequency (RF) radio or infrared (IR) transmitter and functional user controls. The duck, goose or bird retriever is provided with a radio receiver that receives signals from the transmitter and in turn supplies an electrical charge to current-controlled wire that in turn changes length as a charge is applied or removed causing the articulating fin, body; hook, and/or tail to move to one side or the other. The electric motor supplies the function of moving the duck, goose or bird retriever either forward or backward by turning an impeller.

According to another aspect, a fishing pole is provided with a radio frequency (RF) radio or infrared (IR) transmitter and functional user controls. The duck, goose or bird retriever is provided with a radio receiver that receives signals from the transmitter and in turn supplies a signal to an electrical motor or several motors that turns a series of gears and moves an articulating fin, body, hook, and/or tail to one side or the other. The electric motor supplies the function of moving the duck, goose or bird retriever either forward or backward by turning an impeller.

According to another aspect, a fishing pole is provided with a radio frequency (RF) radio or infrared (IR) transmitter and functional user controls. The duck, goose or bird retriever is provided with a radio receiver that receives signals from the transmitter and in turn supplies the signal to the servo and electric motor. The servo then supplies the function of steering the duck, goose or bird retriever by moving linkages attached to a rudder placed at the stern of the duck, goose or bird retriever. The electric motor supplies the function of moving the duck, goose or bird retriever either forward or backward by turning a paddle wheel.

According to another aspect, a fishing pole is provided with a radio frequency (RF) radio or infrared (IR) transmitter and functional user controls. The duck, goose or bird retriever is provided with a radio receiver that receives signals from the transmitter and in turn supplies the signal to actuators and an electric motor. The actuators then supply the function of steering the duck, goose or bird retriever by moving the rudder placed at the stern of the duck, goose or bird retriever. The electric motor supplies the function of moving the duck, goose or bird retriever either forward or backward by turning a paddle wheel.

According to another aspect, a fishing pole is provided with a radio frequency (RF) radio or infrared (IR) transmitter and functional user controls. The duck, goose or bird retriever is provided with a radio receiver that receives signals from the transmitter and in turn supplies an electrical charge to current-controlled wire that in turn changes length as a charge is applied or removed causing the rudder to move to one side or the other. The electric motor supplies the function of moving the duck, goose or bird retriever either forward or backward by turning a paddle wheel.

According to another aspect, a fishing pole is provided with a radio frequency (RF) radio or infrared (IR) transmitter and functional user controls. The duck, goose or bird retriever is provided with a radio receiver that receives signals from the transmitter and in turn supplies a signal to an electrical motor or several motors that turns a series of gears and moves a rudder to one side or the other. The electric motor supplies the function of moving the duck, goose or bird retriever either forward or backward by turning a paddle wheel.

According to still another aspect, a fishing pole is provided with a radio frequency (RF) radio or infrared (IR) transmitter and functional user controls. The duck, goose or bird retriever is provided with a radio receiver that receives signals from the transmitter and in turn supplies the signal to the servo and electric motor. The servo then supplies the function of steering the duck, goose or bird retriever by moving an articulating fin, body, hook, and/or tail of the duck, goose or bird retriever. The electric motor supplies the function, one of moving the duck, goose or bird retriever either forward or backward by turning a paddle wheel.

According to another aspect, a fishing pole is provided with a radio frequency (RF) radio or infrared (IR) transmitter and functional user controls. The duck, goose or bird retriever is provided with a radio receiver that receives signals from the transmitter and in turn supplies the signal to actuators and an electric motor. The actuators then supply the function of steering the duck, goose or bird retriever by moving an articulating fin, body, hook, and/or tail. The electric motor supplies the function of moving the duck, goose or bird retriever either forward or backward by turning a paddle wheel.

According to another aspect, a fishing pole is provided with a radio frequency (RF) radio or infrared (IR) transmitter and functional user controls. The duck, goose or bird retriever is provided with a radio receiver that receives signals from the transmitter and in turn supplies an electrical charge to current-controlled wire that in turn changes length as a charge is applied or removed causing the articulating fin, body, hook, and/or tail to move to one side or the other. The electric motor supplies the function of moving the duck, goose or bird retriever either forward or backward by turning a paddle wheel.

According to another aspect, a fishing pole is provided with a radio frequency (RF) radio or infrared (IR) transmitter and functional user controls. The duck, goose or bird retriever is provided with a radio receiver that receives signals from the transmitter and in turn supplies a signal to an electrical motor or several motors that turns a series of gears and moves an articulating fin, body; and/or tail to one side or the other. The electric motor supplies the function of moving the duck, goose or bird retriever either forward or backward by turning a paddle wheel.

According to another aspect, a fishing pole is provided with a radio frequency (RF) radio or infrared (IR) transmitter and functional user controls. The duck, goose or bird retriever is provided with a radio receiver that receives signals from the transmitter and in turn supplies the signal to the servo and electric motor. The servo then supplies the function of steering the duck, goose or bird retriever by moving linkages attached to a rudder placed at the stern of the duck, goose or bird retriever. The electric motor supplies the function of moving the duck, goose or bird retriever. The electric motor supplies the function of moving the duck, goose or bird retrievers either forward or backward by moving a flipper or articulating tail.

According to another aspect, a fishing pole is provided with a radio frequency (RF) radio or infrared (IR) transmitter and functional user controls. The duck, goose or bird retriever is provided with a radio receiver that receives signals from the transmitter and in turn supplies the signal to actuators and an electric motor. The actuators then supply the function of steering the duck, goose or bird retriever by moving the rudder placed at the stern of the duck, goose or bird retriever. The electric motor supplies the function of moving the duck, goose or bird retrievers either forward or backward by moving a flipper or articulating tail.

According to another aspect, a fishing pole is provided with a radio frequency (RF) radio or infrared (IR) transmitter and functional user controls. The duck, goose or bird retriever is provided with a radio receiver that receives signals from the transmitter and in turn supplies an electrical charge to current-controlled wire that in turn changes length as a charge is applied or removed causing the rudder to move to one side or the other. The electric motor supplies the function of moving the duck, goose or bird retrievers either forward or backward by moving a flipper or articulating tail.

According to another aspect, a fishing pole is provided with a radio frequency (RF) radio or infrared (IR) transmitter and functional user controls. The duck, goose or bird retriever is provided with a radio receiver that receives signals from the transmitter and in turn supplies a signal to an electrical motor or several motors that turns a series of gears and moves a rudder to one side or the other. The electric motor supplies the function of moving the duck, goose or bird retrievers either forward or backward by moving a flipper or articulating tail.

According to still another aspect, a fishing pole is provided with a radio frequency (RF) radio or infrared (IR) transmitter and functional user controls. The duck, goose or bird retriever is provided with a radio receiver that receives signals from the transmitter and in turn supplies the signal to the servo and electric motor. The servo then supplies the function of steering the duck, goose or bird retriever by moving an articulating fin, body, hook, and/or tail of the duck, goose or bird retriever. The electric motor supplies the function of moving the duck, goose or bird retrievers either forward or backward by moving a flipper or articulating tail.

According to another aspect, a fishing pole is provided with a radio frequency (RF) radio or infrared (IR) transmitter and functional user controls. The duck, goose or bird retriever is provided with a radio receiver that receives signals from the transmitter and in turn supplies the signal to actuators and an electric motor. The actuators then supply the function f steering the duck, goose or bird retriever by moving an articulating fin, body, hook and/or tail. The electric motor supplies the function of moving the duck, goose or bird retrievers either forward or backward by moving a flipper or articulating tail.

According to another aspect, a fishing pole is provided with a radio frequency (RF) radio or infrared (IR) transmitter and functional user controls. The duck, goose or bird retriever is provided with a radio receiver that receives signals from the transmitter and in turn supplies an electrical charge to current-controlled wire that in turn changes length as a charge is applied or removed causing the articulating fin, body, hook, and/or tail to move to one side or the other. The electric motor supplies the function of moving the duck, goose or bird retrievers either forward or backward by moving a flipper or articulating tail.

According to another aspect, a fishing pole is provided with a radio frequency (RF) radio or infrared (IR) transmitter and functional user controls. The duck, goose or bird retriever is provided with a radio receiver that receives signals from the transmitter and in turn supplies a signal to an electrical motor or several motors that turns a series of gears and moves an articulating fin, body, hook, and/or tail to one side or the other. The electric motor supplies the function of moving the duck, goose or bird retrievers either forward or backward by moving a flipper or articulating tail.

According to another aspect, any one of the aspects stated above can be used in combination with any of the following types of user controls for transmitting signals to the duck, goose or bird retriever: (1) programmable controller chips; (2) infrared (IR); (3) radio frequency (RF); (4) programmable firmware; (5) blue tooth technology; (6) global positioning (GPS); (7) programmable software; (8) a separate hand-held unit that resides outside of the handle, such as a transmitter from JR, Sony, Futaba or Hitech, using any of the technologies stated in the aspects; (9) free flight control; (10) random configured control.

According to another aspect, any one of the aspects stated above can be used in combination with any of the following types of user controllers: (1) joysticks; (2) force sensitive resisters (FSR); (3) finger touch pads; (4) push buttons/switches; (5) finger balls; (6) various potentiometers; (7) capacitive switching.

According to another aspect, any one of the aspects stated above can be used in combination with any of the following types of mechanisms for propulsion: (1) gas motors; (2) solar motors; (3) rubber band motors; (4) steam motors; (5) wind-up motors; (6) CO2 cartridges; (7) air motors; (8) wind; (9) water or air currents; (10) electric motors.

According to another aspect, any one of the aspects stated above can be used in combination with any of the following types of power: (1) alkaline batteries supplied from various vendors such as Duracell or Energizer; (2) nickel cadmium (NiCad) batteries supplied from vendors such as Sanyo or Panasonic; (3) lithium (LiPoly) batteries supplied from vendors like Kokam; (4) nickel metal hydride (NiMH) batteries supplied from vendors such as Sanyo or Panasonic; (5) solar; (6) water; (7) capacitors.

According to another aspect, any one of the aspects stated above can be used in combination with any of the following types of drive mechanisms: (1) direct drive; (2) shaft drive; (3) flex shaft drive; (4) coupling drive; (5) universal joint drive; (6) gear drive.

According to another aspect, any one of the aspects stated above can be used in combination with any of the following propulsion methods: (1) float/water current; (2) propeller; (3) impeller; (4) jet drive—water; (5) jet drive—air; (6) flipper; (7) articulating fin, body, hook, and/or tail; (8) paddle wheel; (9) wind.

According to another aspect, any one of the aspects stated above can be used in combination with any of the following locations for the propulsion methods: (1) the bow; (2) the stern; (3) the port; (4) the starboard; (5) the top; (6) the keel; (7) anywhere in between any of the above locations.

According to another aspect, any one of the aspects stated above can be used in combination with any of the following steering mechanisms: (1) rudder/elevator; (2) articulating fin, body, hook, and/or tail; (3) articulating jet drive; (4) articulating motor drive; (5) multiple pulsating motors; (6) air blasts; (7) water brakes; (8) air brakes; (9) electromagnets; (10) capacitance switching.

According to another aspect, any one of the aspects stated above can be used in combination with any of the following handles: (1) various casting handles; (2) various spinning handles; (3) various articulating spinning handles; (4) various fly rod handles.

### BRIEF DESCRIPTION OF THE DRAWINGS

Preferred embodiments of the invention are described below with reference to the following accompanying drawings.

FIG. 1 illustrates one waterfowl retrieving environment where a hunter is standing on a peninsula of land inside of a duck blind and has just cast the present invention into an adjacent body of water according to one aspect of the present invention;

FIG. 2 illustrates the waterfowl retrieving environment of FIG. 1 later in time where the hunter has navigated positioning of the retrieved to engage a floating waterfowl carcass and the hunter is using a fishing pole to retrieve the retriever and waterfowl carcass;

FIG. 3 shows a typical side view, simplified version of the waterfowl retriever of the present invention with a swivel-weighted hook;

FIG. 4 shows the waterfowl retriever of FIG. 3 floating in a body of water;

FIG. 5 shows a simplified version of the present invention as it floats in the water with the swivel-weighted hook hanging downward and positioned to engage with a floating waterfowl carcass;

FIG. 6 is a vertical centerline sectional view taken through the remotely-controlled waterfowl retriever of FIG. 6.

FIG. 7 illustrates a simplified functional block diagram for transmitting circuitry within a transmitting control device such as the devices depicted in FIGS. 9 and 10.

FIG. 8 illustrates a functional block diagram for a receiver-controlled device such as the receiver depicted in the remotely-controlled waterfowl retriever of FIG. 6.

FIG. 9 illustrates a fishing pole with a handle component that includes an integrated, or built-in transmitter control device with a joy stick input device and a push button on/off switch.

FIG. 10 is a sectional view of the handle component of FIG. 9 taken along line 10-10 of FIG. 9.

FIG. 11 is a simplified perspective view of an alternative transmitting control device utilizing the control circuitry of FIG. 7 according to another aspect of the invention.

FIG. 12 is a simplified perspective view of a second alternative transmitting control device over that depicted in FIG. 11.

FIG. 13 is a simplified perspective view of a first type of input device used on the transmitting control device of FIGS. 7, 9 and 10.

FIG. 14 is a simplified perspective view of an alternative input device for use on a transmitting control device over that depicted in FIG. 13.

FIG. 15 is a simplified perspective view of a second alternative input device for use on a transmitting control device over that depicted in FIG. 13.

FIG. 16 is a simplified perspective view of a third alternative input device for use on a transmitting control device over that depicted in FIG. 13.

FIG. 17 is a simplified perspective view of a fourth alternative input device for use on a transmitting control device over that depicted in FIG. 13.

FIG. 18 is a simplified perspective view of a fourth alternatively constructed remote-controlled and self-propelled waterfowl retriever.

FIG. 19 is a simplified perspective view of a fifth alternatively constructed remote-controlled and self-propelled waterfowl retriever.

FIG. 20 is a simplified perspective view of a sixth alternatively constructed remote-controlled and self-propelled waterfowl retriever.

FIG. 21 is a simplified perspective view of a seventh alternatively constructed remote-controlled and self-propelled waterfowl retriever.

FIG. 22 is a simplified perspective view of a eighth alternatively constructed remote-controlled and self-propelled waterfowl retriever.

FIG. 23 is a simplified perspective view of a ninth alternatively constructed remote-controlled and self-propelled waterfowl retriever.

FIG. 24 is a simplified perspective view of a tenth alternatively constructed remote-controlled and self-propelled waterfowl retriever.

FIG. 25 is a simplified perspective view of an eleventh alternatively constructed remote-controlled and self-propelled waterfowl retriever.

FIG. 26 is a simplified breakaway perspective view illustrating one rudder assembly utilized with the remote-controlled, self-propelled waterfowl retriever of FIGS. 3-6.

FIG. 27 is a simplified side view depicting one construction for a unitary drive module for use in a self-propelled waterfowl retriever.

FIG. 28 is a simplified side view depicting a first alternative construction for a unitary drive module for use in a self-propelled waterfowl retriever.

FIG. 29 is a simplified side view depicting a second alternative construction for a unitary drive module for use in a self-propelled waterfowl retriever.

FIG. 30 is a simplified side view depicting a third alternative construction for a unitary drive module for use in a self-propelled waterfowl retriever.

FIG. 31 is a simplified side view depicting a fourth alternative construction for a unitary drive module for use in a self-propelled waterfowl retriever.

FIG. 32 is a simplified side view illustrating a first propeller configuration for a self-propelled fishing apparatus, such as a self-propelled bobber or self-propelled waterfowl retriever.

FIG. 33 is a first alternative propeller configuration over that depicted in FIG. 32.

FIG. 34 is a second alternative propeller configuration over that depicted in FIG. 32.

FIG. 35 is a third alternative propeller configuration over that depicted in FIG. 32.

FIG. 36 is a fourth alternative propeller configuration over that depicted in FIG. 32.

FIG. 37 is a simplified, partial and perspective view for an electric motor as utilized in the waterfowl retriever of FIG. 6.

FIG. 38 is a simplified, partial and perspective view illustrating an alternative wind-up motor for driving a self-propelled waterfowl retrieving apparatus.

FIG. 39 is a simplified, partial and perspective view illustrating a second alternative wind-up motor for driving a self-propelled waterfowl retrieving apparatus.

FIG. 40 is a simplified plan view illustrating movement of a remote-controlled waterfowl retriever as it is being towed behind a trolling fishing boat.

FIG. 41 is a simplified plan view showing remote-controlled positioning of a self-propelled waterfowl retriever which has been positioned using a remote control and self-propelled motor without actually casting the waterfowl retriever between a first position and a second position in order to place the retriever into a desirable location on a body of water.

FIG. 42 is a simplified plan view showing repositioning of the waterfowl retriever after the retriever has been cast to place the retriever and fishing line into desired locations on a body of water.

FIG. 43 is a simplified vertical view illustrating an angler in a fishing boat using a remote-controlled and self-propelled waterfowl retriever that is capable of being maneuvered and repositioned at various locations atop the body of water.

FIG. 44 shows a typical side view of a remote-controlled and self-propelled waterfowl retriever attached to a fishing pole.

FIG. 45 is a process flow diagram showing one method for retrieving an object, such as a waterfowl carcass, from a body of water.

### DETAILED DESCRIPTION OF THE PREFERRED EMBODIMENTS

This disclosure of the invention is submitted in furtherance of the constitutional purposes of the U.S. Patent Laws “to promote the progress of science and useful arts” (Article 1, Section 8).

Reference will now be made to preferred embodiments of Applicants' invention comprising a navigable waterfowl retriever 400 used in conjunction with a transmitting control device 52. While the invention is described by way of preferred embodiments, it is understood that the description is not intended to limit the invention to such embodiments, but is intended to cover alternatives, equivalents, and modifications which may be broader than the embodiments, but which are included within the scope of the appended claims.

In an effort to prevent obscuring the invention at hand, only details germane to implementing the invention will be described in great detail, with presently understood peripheral details being incorporated by reference, as needed, as being presently understood in the art.

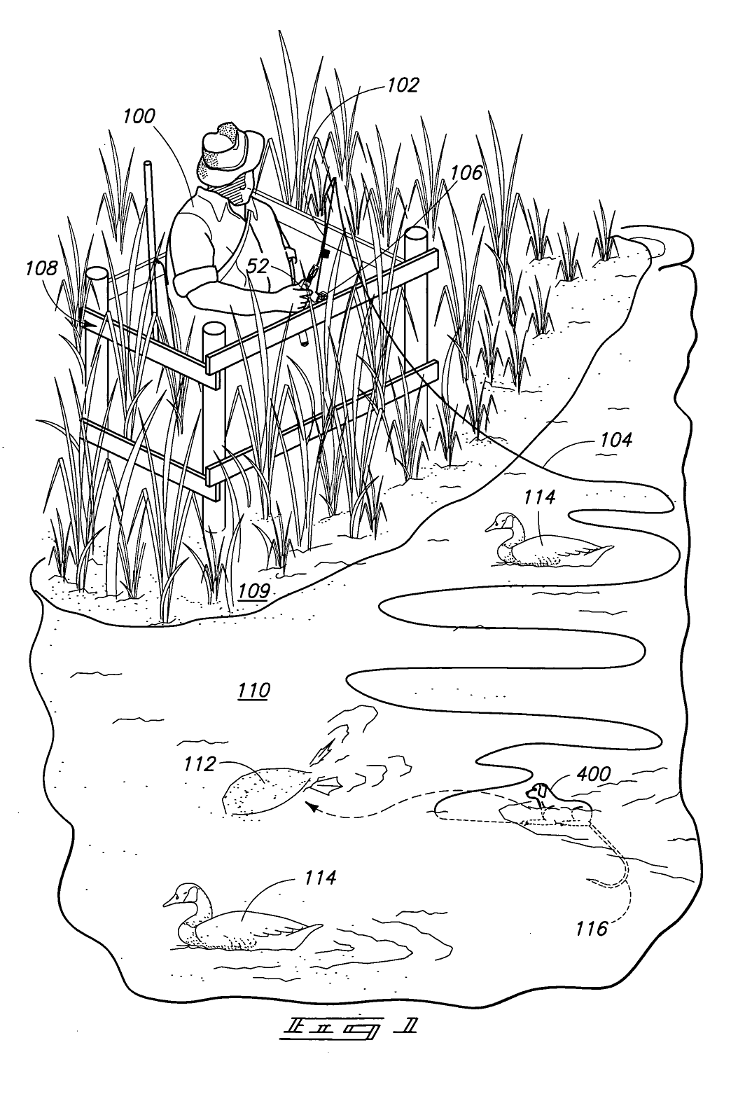

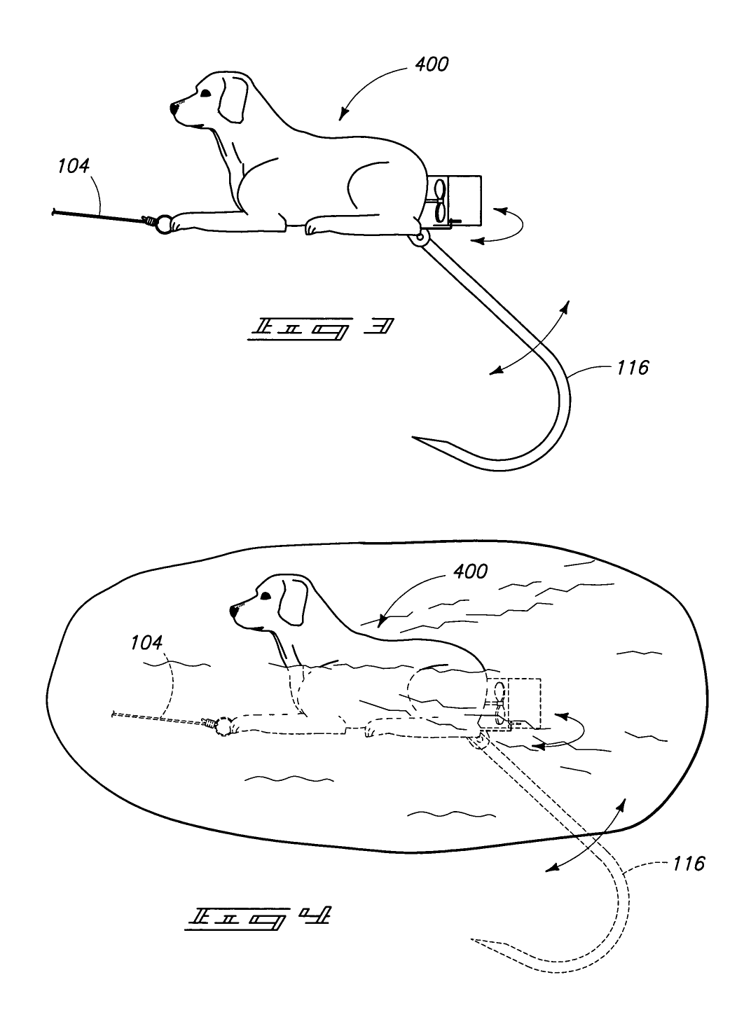

FIG. 1 illustrates one technique by which a user 100 can retrieve waterfowl carcasses 112 from a body of water 110. More particularly, the user comprises a hunter that also performs as an angler. The user stands on the bank 109 of a river or other body of water 110 (or stands in the water within a blind 188) and casts a duck, goose or bird retriever 400 from a fishing pole 102. The duck, goose or bird retriever 400 is attached to the pole 102 by a fishing line 104 using an eyelet 118 (see FIG. 6). A reel 106 is attached to the fishing pole 102, and is used to reel in the duck, goose or bird retriever 400.

In FIG. 1, a user 100 has cast retriever 400 to a location within body of water 110 somewhere in the vicinity of a waterfowl carcass 112. The user 100 then sends input command signals for driving and steering (or navigating) retriever 400 to a position that places waterfowl carcass 112 between retriever 400 and user 100. According to one implementation, user 100 then begins to manually withdraw line 104 into reel 106 so as to force retriever 400 to engage with waterfowl carcass 112 via hook 116. Accordingly, waterfowl carcass 112 is then secured and engaged by hook 116 for retrieval onto shoreline 109 by reeling in line 104 via rotation of reel 106 through action of pole 102.

FIG. 2 illustrates such technique later in time than that depicted in FIG. 1 wherein retriever 400 has been remotely controlled and navigated into a position that will engage with waterfowl carcass 112 when user 100 begins to draw in line 104 by rotating reel 52 so as to cause hook 116 to snag with waterfowl carcass 112. At such point, user 100 no longer needs to use the remote control features of retriever 400, but instead uses the reeling capabilities to retract line 104 and tow waterfowl carcass 112 via hook 116 and retriever 400 for delivery back to shoreline 109.

It is understood that other optional implementations can be used wherein a larger propulsion unit can be provided on retriever 400 such that the propulsion unit on retriever 400 can be used to assist or completely power delivery of waterfowl carcass 112 onto shoreline 109. Further optionally, user 100 in FIG. 1 can deposit retriever 400 within body of water 110 adjacent shoreline 109, after which retriever 400 can be powered and navigated to engage hook 116 with waterfowl carcass 112. Subsequently, user 100 can retrieve waterfowl carcass 112 by reeling in line 104 via fishing pole reel 106 and pole 102.

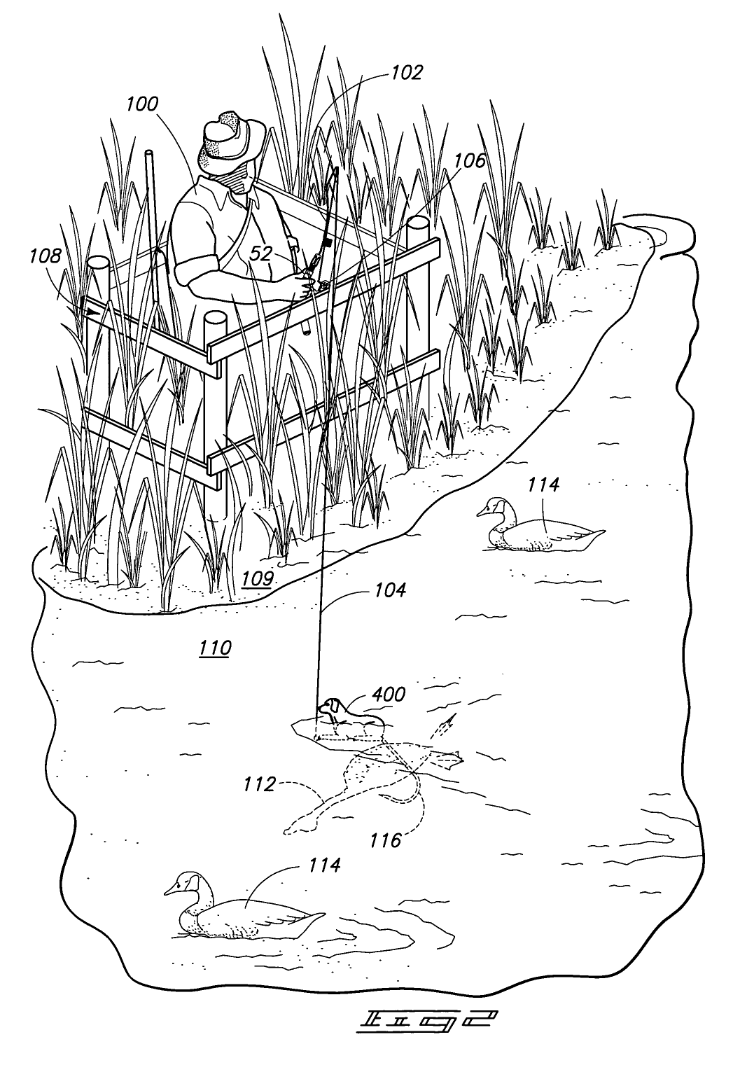

FIG. 3 illustrates a waterfowl retriever 400 tied onto an end portion of a retrieval line, such as a fishing line 104. Hook 116 is preferably weighted from a metal material that sinks in water, and is pivotally affixed onto the tail end of retriever 400 via a pivot pin 113 and bracket (not shown) (see FIG. 6).

FIG. 4 illustrates retriever 400 in its functional, floating position in a body of water, and showing the swivel-weighted hook 116 hanging in a somewhat downward depending engagement position for snagging onto an object within the body of water, such as a partially submerged (and floating) waterfowl carcass.

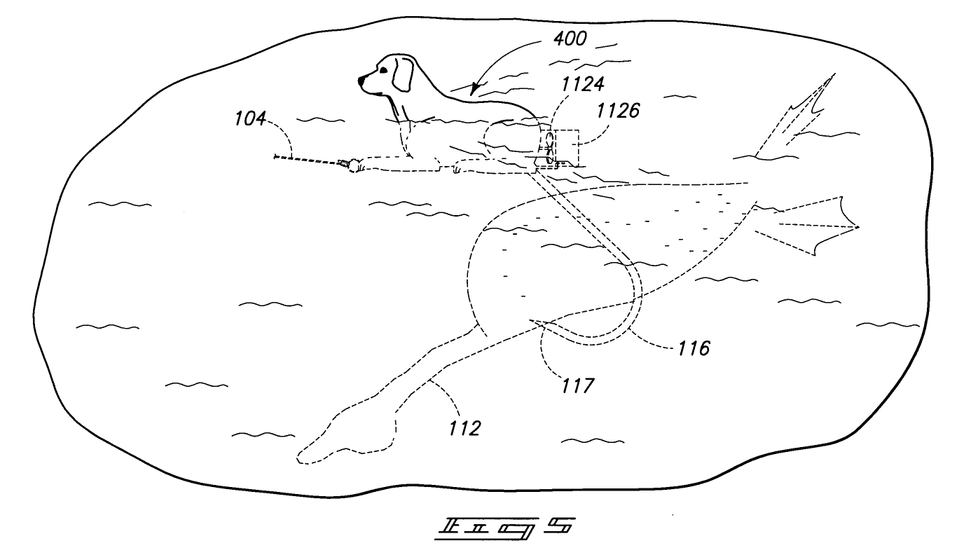

FIG. 5 shows the duck, goose or bird retriever 400 in its functional position in the water with the swivel-weighted hook 116 hanging downward and engaged with a waterfowl carcass 112. Hook 116 terminates in a sharp point 117. Optionally, sharp point 117 can include a barb (not shown). From this position, the hunter/angler 100 can activate the remote control transmitter 134 located in the handle component 111 (of FIG. 10) by pushing forward on the joystick 132 (of FIGS. 7 and 9). A signal is then sent to the receiver 142 (of FIGS. 6 and 8) which relays the signal and, with the battery 146, starts the motor 148 (see FIGS. 6 and 8) that turns the propeller 1124 (see FIG. 6), allowing the duck, goose or bird retriever 400 to move forward. Respectively, if the hunter/angler 100 pulls the joystick 132 backward, the motor 148 then reverses the direction of the propeller 1124 and the duck, goose or bird retriever 400 moves backwards. If the hunter/angler 100 wants to turn the duck, goose or bird retriever 400 left or right, he can do so by moving the joystick 132 in the direction he wants, left or right, while concurrently moving the joystick 132 either forward or backward. The transmitter 134 sends out the signal to receiver 142 (see FIG. 8) and, with the battery 146 (of FIG. 8), starts the motor 148 and turns the propeller 1124 and concurrently a signal is sent to the servo motor 114 that rotates the servo arm 150 in the direction directed by the user, which in turn turns the rudder 1126 left or right. Anti-torque fins could optionally be provided on retriever 400 to prevent the unwanted counter-rotation on the duck, goose or bird retriever 400 due to the rotating propeller 1124, as needed.

The duck, goose or bird retriever 400 moves into any position the hunter/angler 100 chooses via the power of the propeller and rudder. The duck, goose or bird retriever 400 can be cast into the water or can be placed in the water next to the hunter/angler 100 and controller from either starting point. The hunter/angler 100 can manipulate the duck, goose or bird retriever 400 in various axes around obstacles to get into areas that are hard to cast. The ability to maneuver the duck, goose, or bird retriever 400 minimizes casts and allows the hunter/angler 100 to access multiple hard-to-reach locations, minimizing the need to use a dog or boat.

FIG. 6 illustrates construction of the internal components for the remotely-controlled and self-propelled waterfowl retriever 2400 of FIGS. 3-5. It is understood that retriever 400 is constructed with receiving circuitry configured to provide control inputs to a propeller (or a fin) and a rudder (or fin).

As shown in FIG. 6, self-propelled retriever 2400 includes a direct current (DC) electric motor 148 that is provided within a watertight and sealed interior of retriever 2400. An exit shaft on motor 148 extends through a localized seal in a housing for retriever 2400 in order to drive propeller 1124 in rotation outside of the housing of retriever 2400 for driving retriever 2400 in a forward direction (and, optionally, a reverse direction). A servo motor 144 is used to reposition a servo arm in various rotatable positions to rotate a rudder 1126 to desired rotary positions to change direction of retriever 2400 when viewed in plan view. A receiver 142 comprises receiving circuitry 140 (see FIG. 10) for directing operation of motor 148 and servo motor 144. A battery 136 supplies power to control and receiving circuitry within receiver 142, as well as to servo motor 144 and drive motor 148.

As shown in FIG. 6, one construction of retriever 400 is configured with a desired exterior geometric shape comprising a Labrador retriever. According to one construction, a hermetically sealed body, or housing, 122 is inserted within a foam or foam plastic decorative body covering 120. According to such construction, relatively heavy internal components are provided in a bottom portion of body 122 and the geometry of body covering 120 is configured such that buoyancy is provided in a manner that enables the geometric figure of retriever 400 to float in a relatively upright position. Additionally, or optionally, a keel can be provided to the bottom of retriever 400. According to an alternative construction, such keel can include a ballast provided in a bottom portion thereof comprising a relatively heavy piece of metal such as a piece of steel or lead shot.

It is understood that alternative constructions can be provided by directly molding body 122 into a desired geometric shape. It is also understood that alternative geometric configurations can be imparted to retriever 400 such as by using other animal configurations, or providing other geometric configurations. Furthermore, optimal hydrodynamic configurations can be provided to the exterior of retriever 400 in order to increase the speed and ease with which retriever 400 passes through or on top of a body of water.

FIG. 7 illustrates transmitting circuitry 130 that is incorporated within a handle component for a handle on a fishing rod, as depicted below with reference to FIGS. 9 and 10. More particularly, a logic function block diagram is illustrated in FIG. 7 to show how a user provides input signals via a joystick 132 to navigate a waterfowl retrieval apparatus such as a self-propelled waterfowl retriever into desired positions within a body of water. For example, inputs from joystick 132 are sent to transmitter 134 comprising transmitting circuitry. Transmitting circuitry includes an antenna that transmits wireless signal information to a receiver 142 (see FIG. 8) which has similar receiving circuitry and a receiving antenna therein. A battery 136 supplies power to transmitting circuitry 130. An on/off switch 138 enables a user to turn power supply on and off from battery 136 for transmitting circuitry 130.

FIG. 8 illustrates a logic function block diagram for a remotely-controlled and self-propelled waterfowl retriever. Alternatively, a remotely-controlled and self-propelled retriever can have similar circuitry configured to move either a propeller or fin and one or more rudders or dive planes. As shown in FIG. 8, a receiver 142 provides receiving circuitry 140 that receives a signal that has been transmitted from transmitting circuitry 130 (of FIG. 7). In this manner, a user can provide input signals that are received via receiver 142 and which are used to direct operation of a servo motor 144 and a drive motor 148 in order to properly position a rudder 1126 and propeller 1124, respectively, to a user-desired position. In this manner, a user can navigate a self-propelled retriever to desired positions within a body of water by sending desired input signals via receiver 142 to servo motor 144 and drive motor 148 to engage and retrieve a waterfowl carcass. A supply of power is provided via a direct current (DC) battery 146 to receiver 142, servo motor 144, and drive motor 148. Servo motor 144 pivotally positions a servo arm 150 in order to move a rudder to a left position, a right position, or an intermediate position. Likewise, drive motor 144 can be configured to drive a propeller 1124 in either a forward direction or a reverse direction. Furthermore, drive motor 148 can be turned off in order to stop motion of propeller 1124 so as to position a waterfowl retriever into a desired, stationary position within a body of water. It is further understood that dive planes can be added to the circuitry of FIG. 8 via the addition of another servo motor(s) and servo arm(s) in order to rotatably position dive planes in a manner that can be used to adjust the depth of a retriever as it is being propelled atop (or through) a body of water via rotation of propeller 1124.

FIG. 9 is a side elevational view of a fishing pole 102 having a fishing rod 103 and a handle 404 constructed according to techniques disclosed in pending U.S. patent application Ser. No. 10/607,285 entitled “Fishing Rod” filed Jun. 25, 2003, and Ser. No. 10/655,792 entitled “Fishing Rod Connector, and Connector Assemblies for Fishing Poles” filed Sep. 4, 2003, both of which are herein incorporated by reference. Additionally, handle assembly 404 of FIG. 10 includes a handle component 111 that includes a hollow chamber in which transmitting circuitry 130 (see FIG. 7) is provided therein. More particularly, transmitting circuitry 130 includes a joystick 132 that extends laterally from handle component 111 and an on/off switch 138 that extends downwardly from handle component 111. Transmitting circuitry 130 includes a transmitter 134 having a transmitting antenna extending therefrom. According to one construction, the transmitting antenna can be encased within handle component 111. According to another construction, the antenna of transmitter 134 can extend externally of handle component 111 via a sealed aperture provided in handle component 111. Additionally, a direct current (DC) battery 136 is also provided within handle component 111.

More particularly, handle component 111 comprises a rigid aluminum tube 141 that is surrounded by a cork cover 143. A plug 145 is provided in a distal end of tube 144 for threadingly receiving an end cap 147 that retains one or more counter weights 149 along such distal end of handle component 111.

Weights 149 can be added or removed from handle component 111 in order to balance a fishing pole pursuant to techniques that were taught in U.S. patent application Ser. No. 10/679,224 entitled “Fishing Poles, Counter-Balancing Apparatus for Fishing Poles and Fishing Pole Handles, and Methods for Balancing Fishing Poles” and filed Oct. 2, 2003, herein incorporated by reference.

According to one construction, transmitter 134 includes transmitting circuitry 130 that is miniaturized in order to fit within tube 141. Additionally, seals can be added to weights 149 and end cap 147 in order to seal the interior of tube 141 so as to protect electronic components encased therein. Likewise, joystick 132 and switch 138 can be provided with O-ring seals in order to seal joystick 132 and switch 138 with tube 141.

One suitable construction for transmitting circuitry 130 comprises a 2.4 GHz ISM band transceiver, Model No. MC13192, sold by Freescale Semiconductor, Inc., 6501 William Cannon Drive West, Austin, Tex. 78735. Freescale Semiconductor, Inc. was previously referred to as Motorola's Semiconductor Products Sector (SPS) of Motorola, Inc. Such exemplary transmitting circuitry comprises transmitting and receiving circuitry configured in a miniature chip set that uses infrared (IR) technology and an accelerometer to transmit signals to a similar and compatible receiver. Such a transceiver supports IEEE 802.15.4 wireless standard supporting star and mesh networking. Such transceiver can also be used with a microcontroller (MCU) and accompanying software in order to provide a cost-effective and miniature solution for short-range data links and networks. Interfacing with an MCU can be accomplished by using a four-wire serial peripheral interface (SPI) connection, which can enable the use of a variety of processors. Accordingly, software and processors can be scaled in order to fit applications ranging from a simple point-to-point system, all the way through a complete networking solution.

Optionally, any of a number of known transmitting and receiving circuitries can be utilized for the implementations depicted in FIGS. 7 and 8. One suitable alternative construction for transmitter 130 of FIG. 7 comprises a Hitech Laser 4 transmitter available from Hitech RCD USA, Inc., of 12115 Paine St., Poway, Calif. 92064. For example, a Cirrus Micro Joule FM receiver can be utilized for receiving circuitry. With respect to power supplies, respective batteries can comprise any DC batteries such as Triple A-type lithium rechargeable batteries or any other store-purchased small battery, such as a watch battery. Furthermore, one exemplary servo motor comprises a Cirrus CS-3 Micro Joule servo motor.

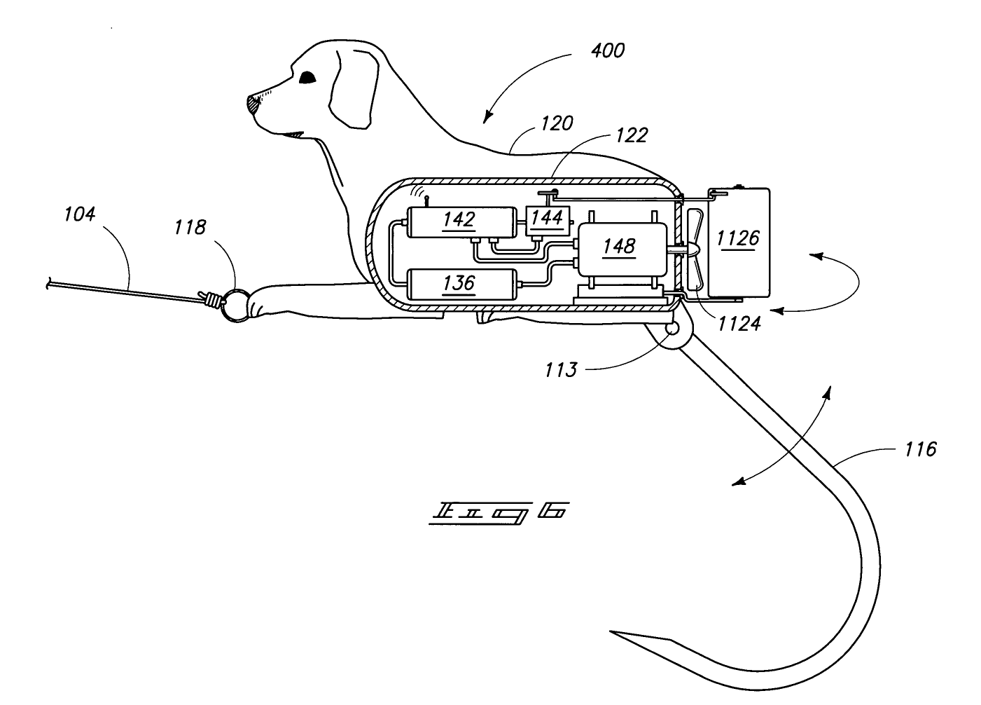

FIG. 11 illustrates a first alternative construction for a transmitter over that depicted in FIGS. 9-10. Likewise, FIG. 12 illustrates a second alternative construction for a transmitter over that depicted in FIGS. 9-10.

FIG. 13 illustrates construction of joystick 32 including a pivotable X and Y axis base component 404 for directing X and Y axis positioning when navigating a navigable fishing apparatus such as a fishing lure or a fishing bobber. X axis motion will impart left and right positioning for a rudder, whereas Y axis positioning of joystick 132 will impart forward and reverse propulsion to a propeller.

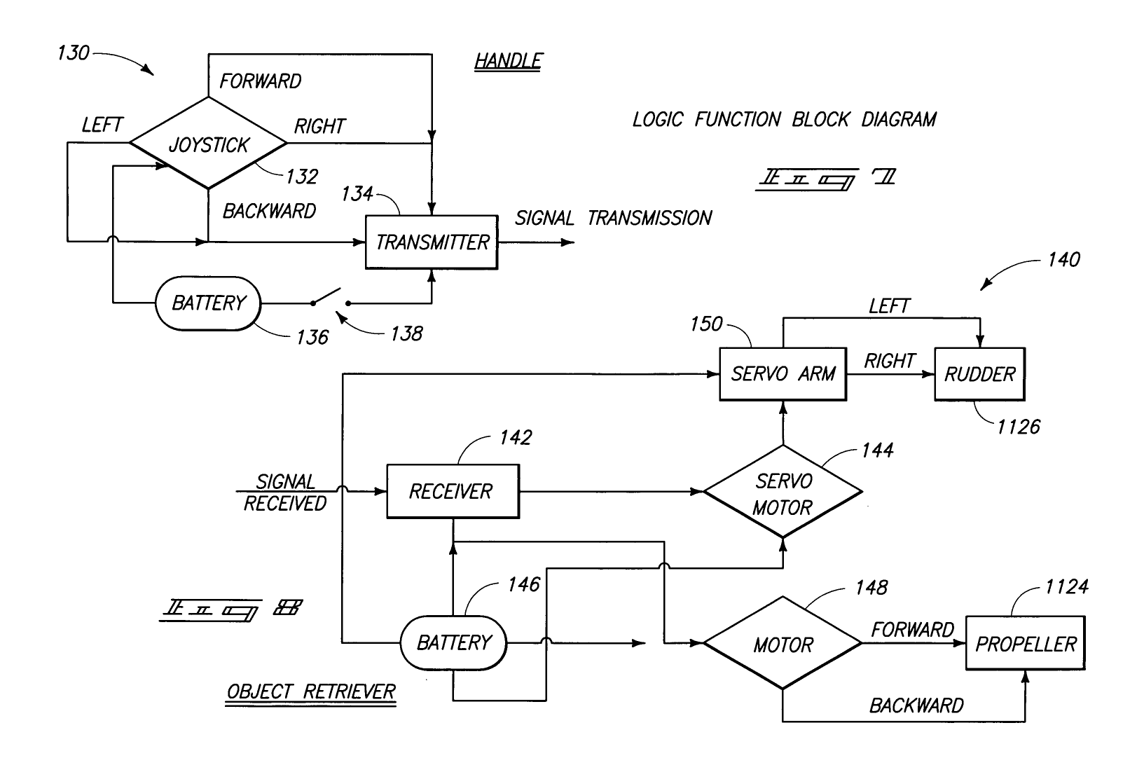

FIG. 14 illustrates an optional construction for a user input device for a fishing pole transmitter comprising a finger touch pad 1132.

FIG. 15 illustrates a second alternatively constructed input device comprising a finger ball input device 2132.

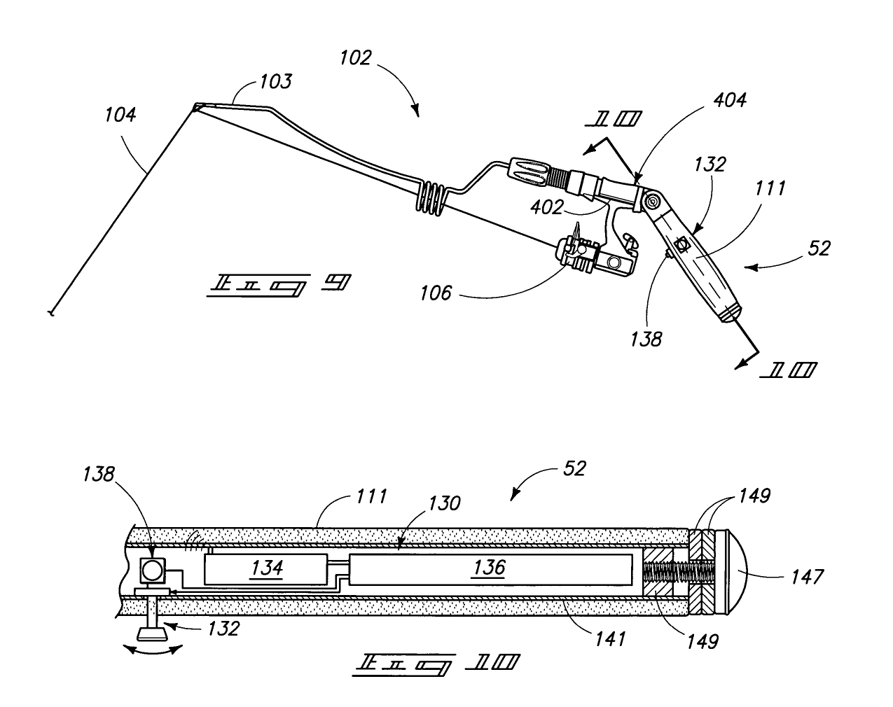

FIG. 16 illustrates one construction for an on/off switch 3132 as implemented in the fishing pole of FIGS. 9-10 and further illustrating another construction for a user input device.

FIG. 17 illustrates yet another alternative construction for a user input device comprising a linear potentiometer switch 4132.

FIG. 18 illustrates a fourth embodiment retriever 3400 having an impeller 2124 comprising a circumferential array of propeller blades and a rudder 414.

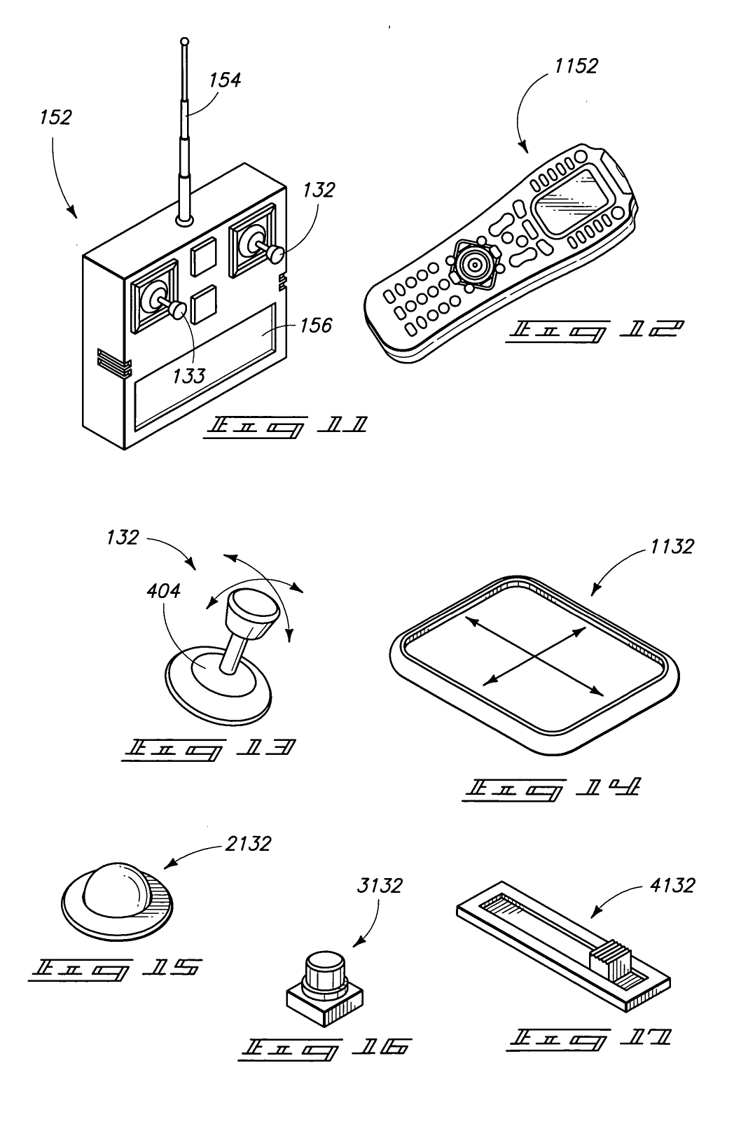

FIG. 19 illustrates a fifth alternatively constructed remote-controlled and self-propelled retriever 4400 having a flipper that is moved laterally in order to propel retriever 4400 in a forward direction.

FIG. 20 is a sixth alternatively constructed retriever 5400 comprising a jet drive 420 that is configured to propel retriever 5400 in a forward direction.

FIG. 21 illustrates a seventh alternatively constructed remote-controlled and self-propelled retriever having a paddle wheel 422 carried by a body 400 of lure 6400.

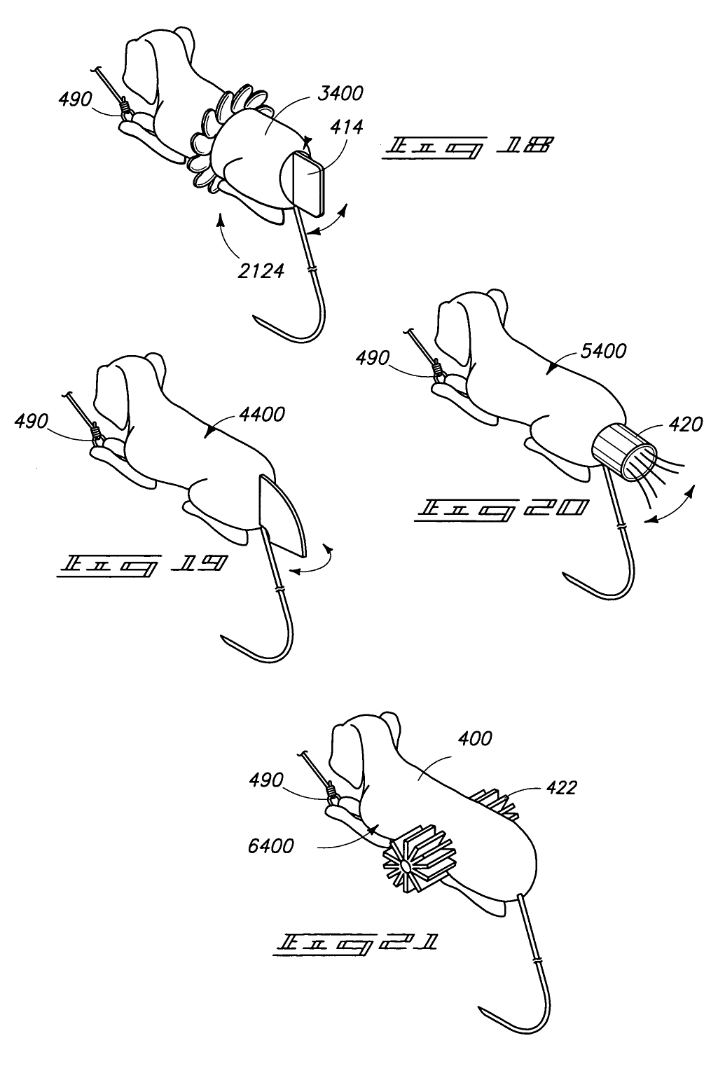

FIG. 22 is an eighth alternatively constructed retriever 9400 having an articulating jet drive with an articulating nozzle.

FIG. 23 is a ninth alternatively constructed retriever 8400 that has a water break, or flap, underneath each of a pair of stationary wings that can be extended and retracted to increase water drag on retriever 8400 to break motion of retriever 8400.

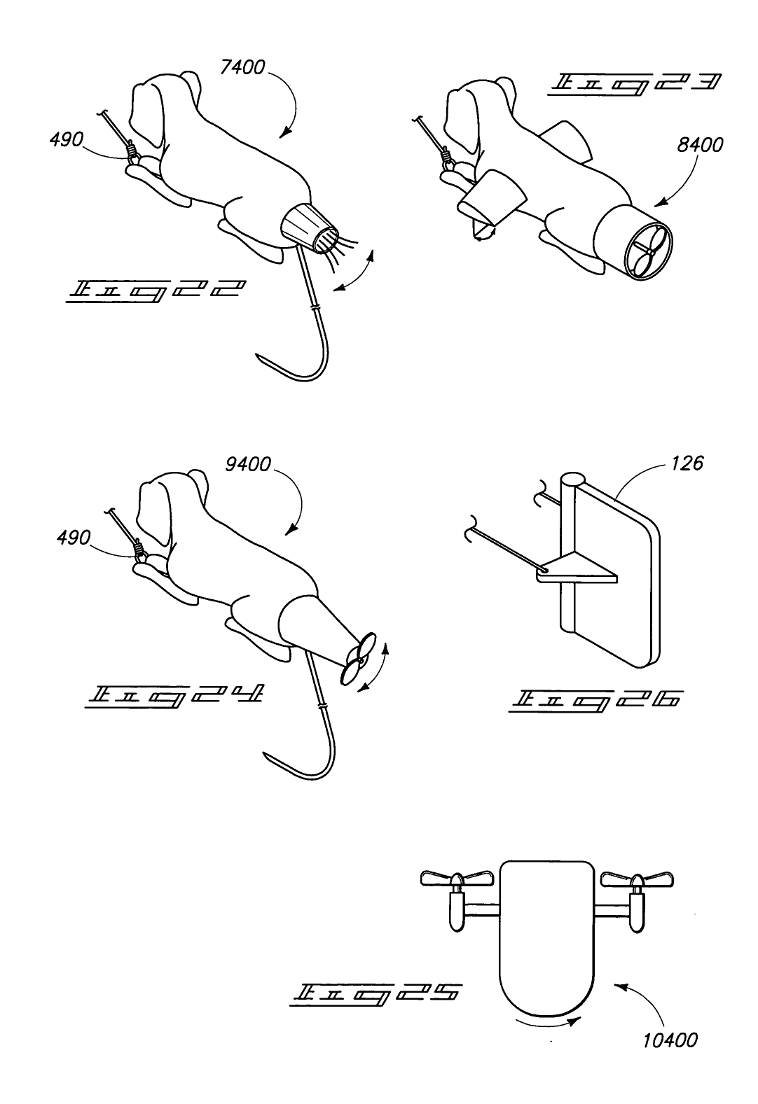

FIG. 24 illustrates a tenth alternatively constructed retriever 9400 having an articulating body that terminates in a propeller. By articulating the body segment, the propeller can be pointed in order to change the propulsion direction of retriever 9400.

FIG. 25 illustrates the utilization of multiple motor pods, each having a propeller thereon for driving a retrieval apparatus such as a self-propelled waterfowl retriever.

FIG. 26 illustrates one construction for a rudder usable with the waterfowl retriever disclosed herein.

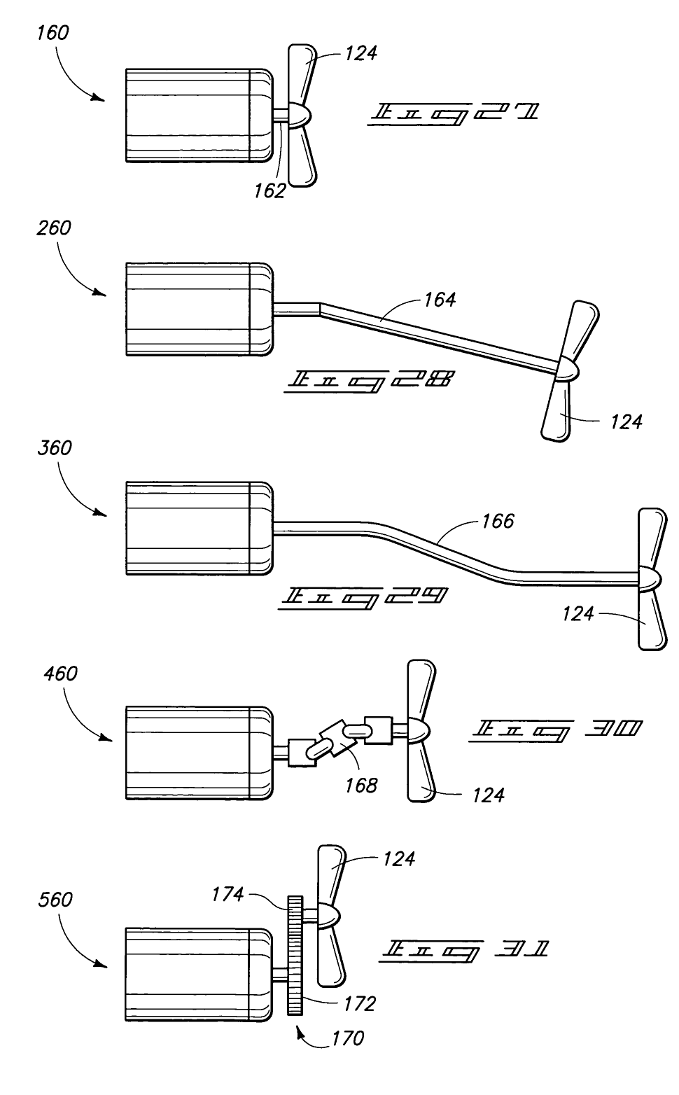

FIGS. 27-31 illustrate various constructions for a unitary drive module that has an electric drive motor and a propeller therein.

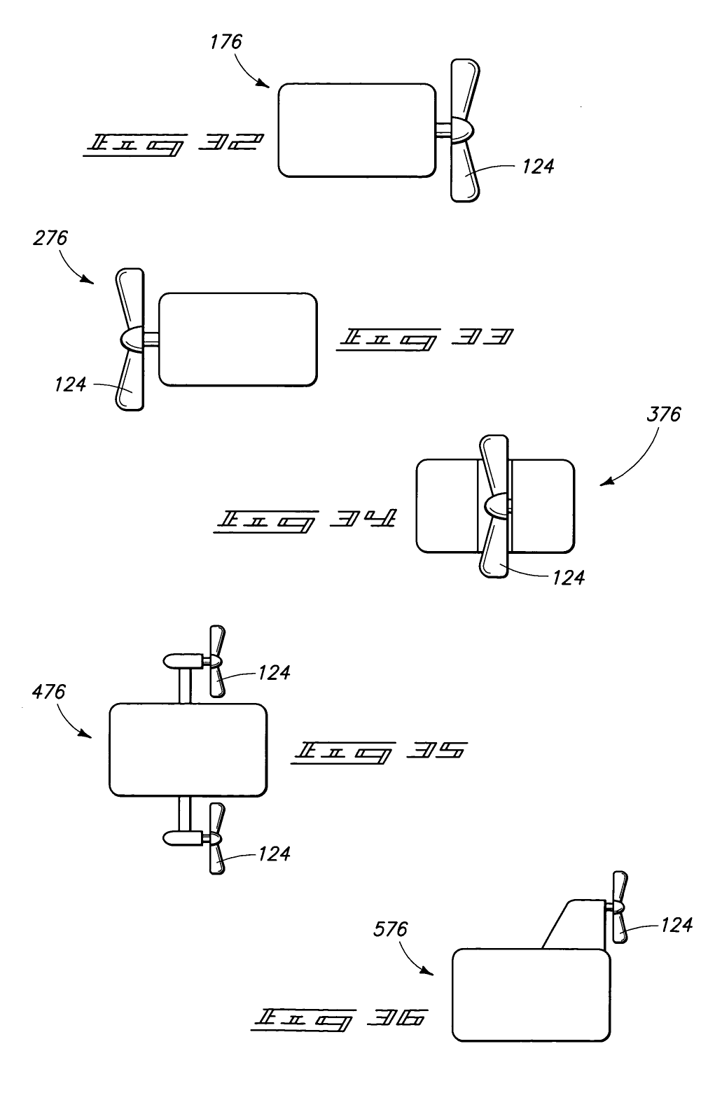

For example, FIG. 27 illustrates a drive module 160 having a motor shaft 162 on which a propeller is directly driven by motor shaft 162 rearwardly of the motor on the module 160. FIG. 28 illustrates a drive module having a draft shaft 164 that is flexibly coupled to the motor shaft to provide an angular drive for driving a propeller 124 at an angle. FIG. 29 illustrates another construction for a module 360 having a flexible drive shaft 166 comprising a cylindrical spring that is provided within a tube in which it is rotated to drive propeller 124. FIG. 30 illustrates a third alternative construction for a drive module 460 having coupling/universal joints within a drive shaft 168 for driving a propeller 124. FIG. 31 illustrates a fourth alternative construction drive module 560 having a gear drive assembly 170 including a pair of gears 172 and 174 configured to drive a propeller 124 at the rear end of a motor.

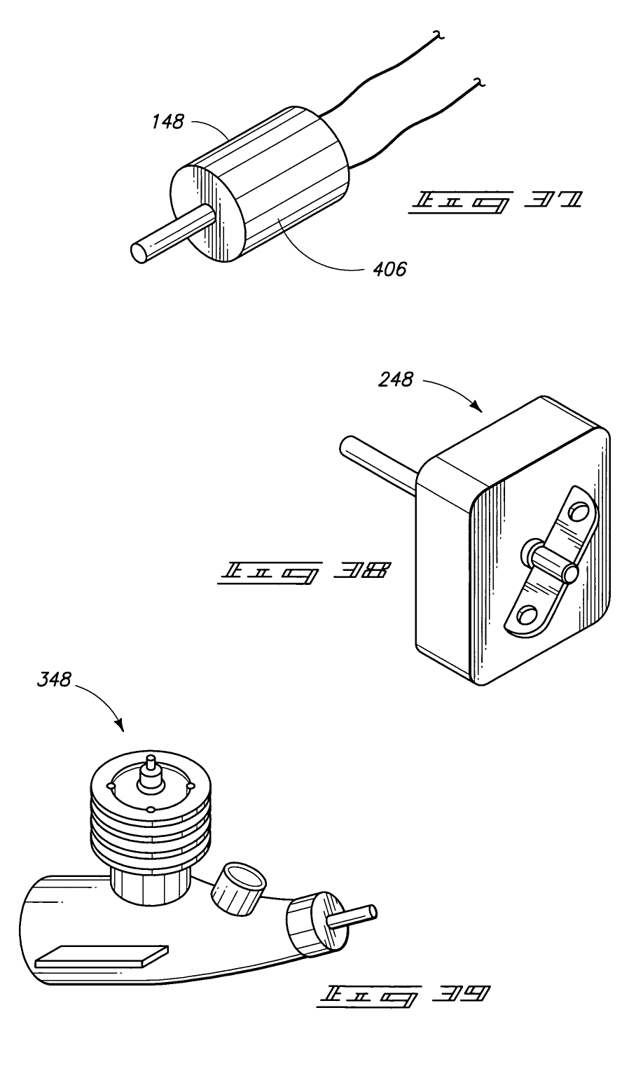

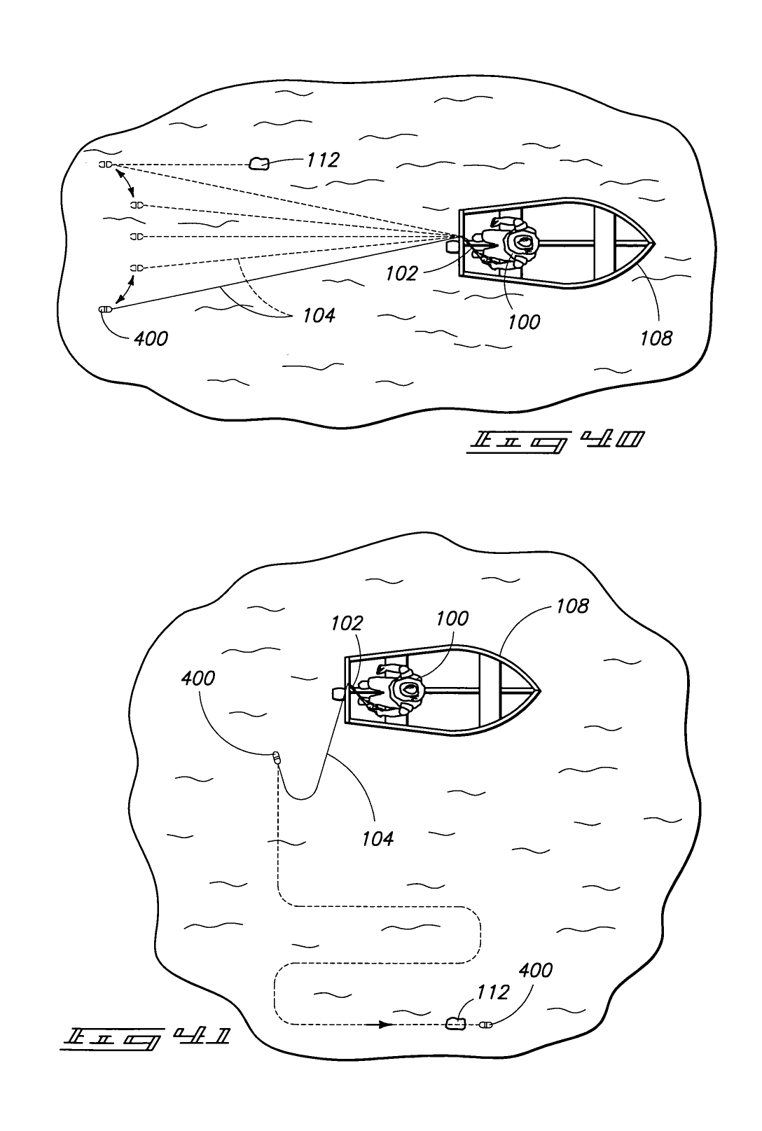

FIGS. 32-36 illustrate various propeller configurations for a waterfowl retrieval apparatus. For example, FIG. 32 shows a first propeller configuration 176 having a propeller 124 mounted on the rear of a fishing apparatus. FIG. 33 shows a second configuration 276 with a propeller 124 at the forward end of a waterfowl retrieval apparatus. FIG. 34 shows a third configuration 376 with a propeller 124 provided in an intermediate cavity within a waterfowl retrieval apparatus. FIG. 35 shows a configuration 476 with a pair of side mounted propellers 124 on a waterfowl retrieval apparatus. FIG. 36 illustrates a fourth alternative configuration 576 having a top mounted propeller.

FIG. 37 illustrates one exemplary DC motor 148 having a motor housing 406.

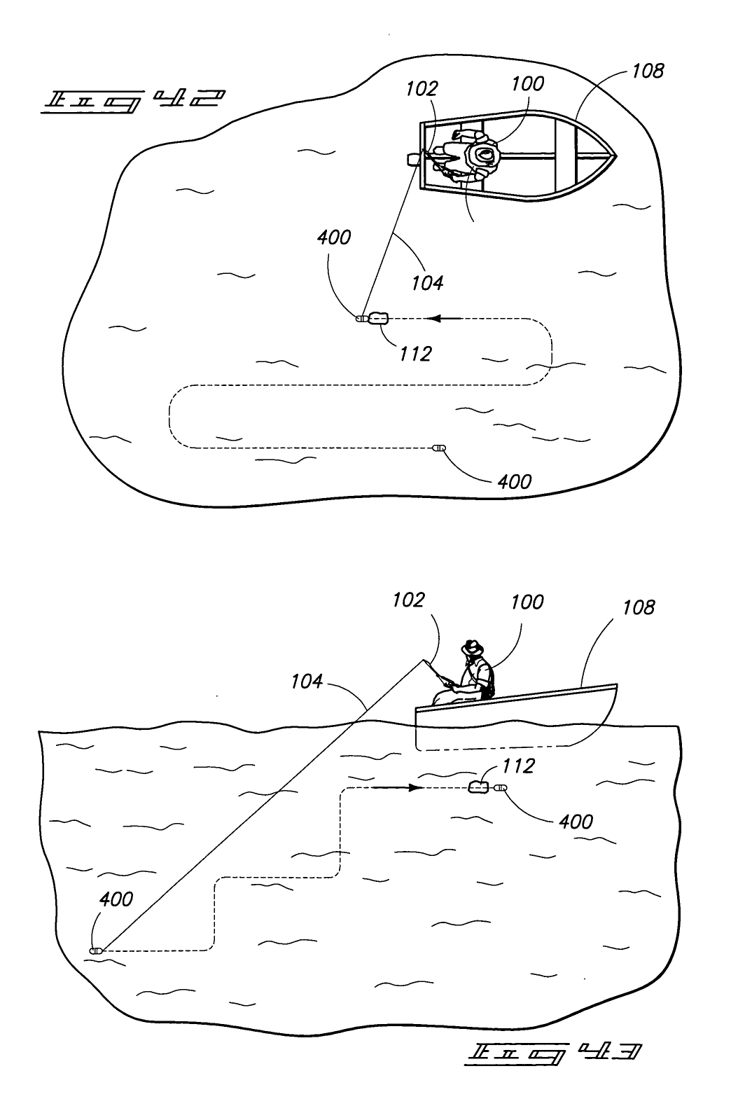

FIG. 38 illustrates a wind-up motor having an internal coil spring for driving a waterfowl retrieval apparatus.

FIG. 39 shows a second alternative motor construction comprising a gasoline motor 348 usable in a waterfowl retrieval apparatus.

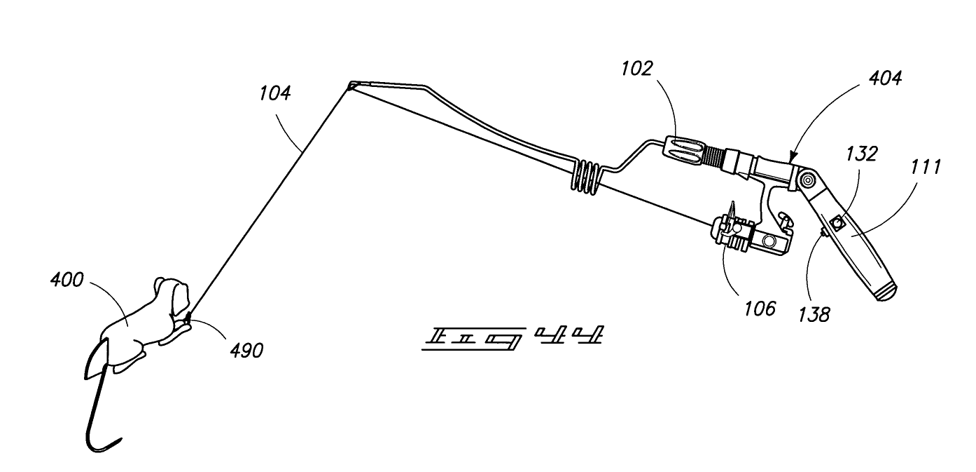

FIG. 40 illustrates navigation of a remotely-controlled waterfowl retriever 400 on the top surface of a body of water behind a motorized boat 108 to capture a waterfowl carcass 112.

FIG. 41 illustrates navigation of a self-propelled and remotely-controlled waterfowl retriever 400 across the top surface of a body of water which has been navigated from a boat 108 by a user 100 without casting retriever 400 from a first position to a second position across a navigable course. In the process, retriever 400 ensnares a waterfowl carcass 112 that is floating on the surface of the water.

FIG. 42 is a plan view illustrating navigation of a waterfowl retriever 400 from a first position to a second position after an angler 100 has cast the retriever from a boat 108. In the process, retriever 400 has been navigated so as to ensnare a waterfowl carcass 112.

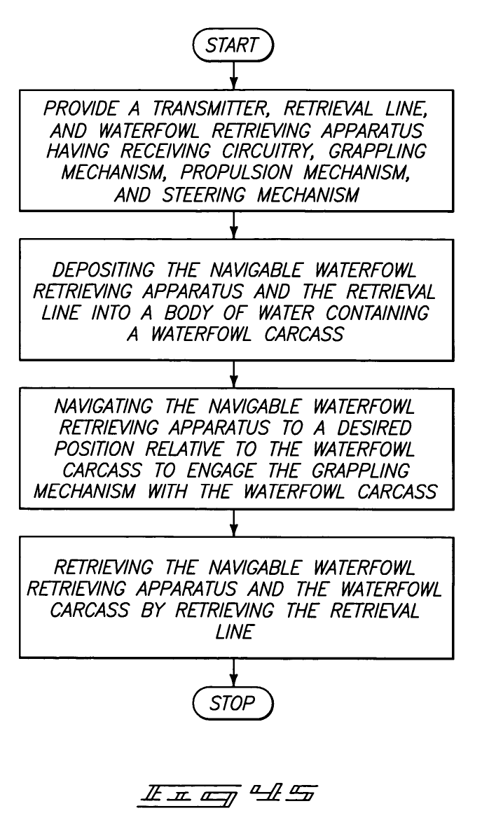

FIG. 43 illustrates navigation of a remotely-controlled and self-propelled waterfowl retriever 400 from a first position to a second position beneath the surface of the water using dive planes that are servo controlled. In the process, retriever 400 is navigated to ensnare a submerged waterfowl carcass 112.

FIG. 44 illustrates a fishing pole 102 with a handle component 111 having a transmitter therein for controlling a self-propelled waterfowl retriever 1400. A reel 106 is affixed to a reel seat 404. A joystick 132 and an on/off switch 138 are visibly positioned on handle component 111.

FIG. 45 is a process flow diagram showing one method for retrieving an object, such as a waterfowl carcass, from a body of water. In Step “S1”, ______ by providing a transmitter, a retrieval line, and a waterfowl retrieving apparatus having receiving circuitry, a grappling mechanism, a propulsion mechanism, and a steering mechanism. After Step “S1”, the process proceeds to Step “S2”.

In Step “S2”, the process proceeds with depositing the navigable waterfowl retrieving apparatus and a retrieval line into a body of water containing a waterfowl carcass. After Step “S2”, the process proceeds to Step “S3”.

In Step “S3”, the process proceeds with navigating the navigable waterfowl retrieving apparatus to a desired position relative to the waterfowl carcass in order to engage the grappling mechanism with the waterfowl carcass. After completing Step “S3”, the process proceeds to Step “S4”.

In Step “S4”, the process continues with retrieving the navigable waterfowl retrieving apparatus and the waterfowl carcass by retrieving the retrieval line. A fishing reel and fishing pole are used to retrieve which provides the retrieval line.

Optionally, the step of casting the retrieval line and the navigable waterfowl retrieving apparatus can be implemented via a fishing pole in the general direction toward a waterfowl carcass that is provided within a body of water. An even further step is provided by navigating the navigable waterfowl retrieving apparatus after casting the navigable waterfowl retrieving apparatus into the body of water.

In compliance with the statute, the invention has been described in language more or less specific as to structural and methodical features. It is to be understood, however, that the invention is not limited to the specific features shown and described, since the means herein disclosed comprise preferred forms of putting the invention into effect. The invention is, therefore, claimed in any of its forms or modifications within the proper scope of the appended claims appropriately interpreted in accordance with the doctrine of equivalents.

1. A navigable waterfowl retrieving apparatus, comprising:
a body having a fishing line eyelet;
a propulsion mechanism supported by the body;
a steering mechanism supported by the body; and
a waterfowl grappling mechanism supported by the body and configured to couple with a floating waterfowl carcass when engaged with the grappling mechanism via navigable movement of the body about a body of water.

2. The navigable waterfowl retrieving apparatus of claim 1 wherein the body comprises a buoyant body.

3. The navigable waterfowl retrieving apparatus of claim 1 wherein the grappling mechanism comprises a hook.

4. The navigable waterfowl retrieving apparatus of claim 4 wherein the hook comprises a barbed hook.

5. The navigable waterfowl retrieving apparatus of claim 1 wherein the propulsion mechanism comprises a propeller, a drive motor, and a drive shaft coupling the propeller with the drive motor.

6. The navigable waterfowl retrieving apparatus of claim 1 wherein the steering mechanism comprises a rudder pivotally affixed to the body.

7. The navigable waterfowl retrieving apparatus of claim 6 wherein the steering mechanism further comprises a servo motor coupled with the rudder to pivotably positioning the rudder.

8. The navigable waterfowl retrieving apparatus of claim 7 wherein the steering mechanism further comprises receiving circuitry coupled with the servo motor to control positioning of the rudder response to a received control signal.

9. The navigable waterfowl retrieving apparatus of claim 1 wherein the body is sized sufficiently small to enable casting of the retrieving apparatus via a line and a fishing pole.

10. A retrieving apparatus for waterborne objects, comprising:
a body having an eyelet for affixing a line;
a propulsion mechanism supported by the body;
a steering mechanism supported by the body; and
an object engagement mechanism supported by the body and configured to couple with a floating object when engaged with the object engagement mechanism via navigable movement of the body about a body of water.

11. The navigable retrieving apparatus of claim 10 wherein the body comprises hermetically sealed housing in a decorative body covering received about the housing.

12. The navigable retrieving apparatus of claim 11 wherein the decorative body covering is configured in the shape of a dog.

13. The navigable retrieving apparatus of claim 12 wherein the decorative body covering is configured in the shape of a Labrador retriever.

14. The navigable retrieving apparatus of claim 10 wherein the propulsion mechanism comprises a motor, a drive shaft, and a propeller extending from the body.

15. The navigable retrieving apparatus of claim 10 wherein the steering mechanism comprises a rudder pivotally supported relative to the body and having an actuating lever driver by a servo motor to pivotally position the rudder into a desired position to navigate the retrieving apparatus in a body of water.

16. The navigable retrieving apparatus of claim 10 wherein the object engagement mechanism comprises a hook.

17. The navigable retrieving apparatus of claim 16 wherein the hook comprises a barb provided on a sharp end portion of the hook.

18. A method for retrieving a waterfowl carcass from a body of water, comprising:
providing a transmitter, a retrieval line, and a waterfowl retrieving apparatus having receiving circuitry, a grappling mechanism, a propulsion mechanism, and a steering mechanism;
depositing the navigable waterfowl retrieving apparatus and the retrieval line into a body of water containing a waterfowl carcass;
navigating the navigable waterfowl retrieving apparatus to a desired position relative to the waterfowl carcass to engage the grappling mechanism with the waterfowl carcass; and
retrieving the navigable waterfowl retrieving apparatus and the waterfowl carcass by retrieving the retrieval line.

19. The method of claim 8 further comprising providing a fishing pole and a fishing reel mounted onto the fishing pole and configured to store the retrieval line for withdrawal and retrieval.

20. The method of claim 19 wherein the transmitter is provided within a handle portion of the fishing pole.

21. The method of claim 19 further comprising casting the retrieval line and the navigable waterfowl retrieving apparatus from the fishing pole in a general direction of the waterfowl carcass.

22. The method of claim 21 further comprising navigating the navigable waterfowl retrieving apparatus after casting the navigable waterfowl retrieving apparatus.
